(19) United States
(12) Patent Application Publication
(10) Pub. No.: US 2012/0005643 A1
(43) Pub. Date: Jan. 5, 2012

(54) System and Method for Placing Integrated Circuit Functional Blocks According to Dataflow Width

(75) Inventors: Friedrich Schroeder, Boeblingen (DE); Alexander Woerner, Boeblingen (DE); Stefan Bonsels, Boeblingen (DE); Tobias Werner, Boeblingen (DE)

(73) Assignee: INTERNATIONAL BUSINESS MACHINES CORPORATION, Armonk, NY (US)

(21) Appl. No.: 12/827,027

(22) Filed: Jun. 30, 2010

(51) Int. Cl. G06F 17/50

(52) U.S. Cl. 716/119; 716/126

(57) ABSTRACT

Macroblock placement for an integrated circuit register-transfer level design is enhanced by tagging blocks having a set of functions as usage element definitions that have a minimum input signal width, such as tags added to a netlist of the design. Tagged blocks aid preferred and regular placement of library cells that are morphed to adapt for reduced congestion and improved utilization.

### BACKGROUND OF THE INVENTION

1. Field of the Invention

The present invention relates in general to the field of integrated circuit design, and more particularly to a system and method for placing integrated circuit functional blocks according to dataflow width.

2. Description of the Related Art

Integrated circuits are fabricated by etching a design of cell formations into silicon or a similar semiconductor substrate and interconnecting the formations with metal wires or other conducting material. A cell is a group of one or more basic circuit elements, such as transistors or capacitors, which perform a function. Each cell typically includes one or more pins with wires interconnecting the pins so that the cells interact in a desired manner. A “net” is a set of two or more pins to be connected. A netlist is a list of nets that is typically developed during design of an integrated circuit hardware description. The design of an integrated circuit generally involves transforming a circuit description of cells and nets into a geometric description that is used to create a mask for etching a semiconductor substrate. During the design process, cells are sometimes grouped into logical blocks that are maintained in a library for repeated use. The logical blocks, also known as leaf cells, have varying sizes and shapes to accomplish desired functions, such as processing, memory, timing, Input/Output (I/O), etc. Since a typical integrated circuit can have large numbers of circuits, the design process is typically automated with computer tools that use the library of blocks. Macroblocks, also known as macros, are multiple instances of leaf cells taken from design libraries.

Integrated circuit design generally attempts to arrange cells in three dimensional space to have an efficient interconnection or routing scheme for a desired functionality. Poor placement of cells effects integrated circuit performance by reducing dataflow between logical blocks, such as by inhibiting timing parameters, causing congestion and providing poor utilization of logical elements. One technique for determining cell placement is Hierarchical Unit Design, which uses a divide and conquer strategy to isolate congested, timing critical and dataflow logic, such as with custom macros and RLM macros. However, Hierarchical Unit Design tends to be very resource intensive, offers low flexibility after an initial floorplan and macroblock sizing is accomplished and uses artificial macroblock boundaries that tend to have inefficient placement with high overhead. Custom Macro Placement provides a regular dataflow structure with low congestion that is well adapted for regular dataflow logic and high density placement having good utilization, however, Custom Macro Placement is resource intensive by using manual schematic building and offers low flexibility to adapt to logic, size and aspect ratio changes. RLM Macro Placement, also known as synthesis, uses a fully automated process with low resource demands that provides highly flexible placement that is adaptable to change, however, often results in irregular structures, higher congestion and more wiring resources that provide low density with low utilization. An alternative to Hierarchical placement is flat unit placement, such as with SuperRLM or Large Block Synthesis. A SuperRLM has no hierarchy and does not use macros, but rather uses leaf cells. Synthesis provides an attractive approach to leaf cell placement due to its automation, however, tends to provide areas of congestion that detract from integrated circuit performance. Synthesis generally has difficulty placing dataflow logic in an efficient manner so that utilization of integrated circuits designed with synthesis tends to be suboptimal. With flat unit placement synthesis techniques, such as SuperRLM and Large Block Synthesis, regular structures are manually placed with full custom placement.

### SUMMARY OF THE INVENTION

Therefore, a need has arisen for a system and method which provides automated detection and dynamic handling of regular structures of logical blocks within an integrated circuit design for automatically placing regular structures in synthesized macros.

In accordance with the present invention, a system and method are provided which substantially reduce the disadvantages and problems associated with previous methods and systems for placing regular structures in synthesized macros within an integrated circuit design. Dataflow blocks of a design are automatically identified by usage box definition and width and then automatically aligned with associated pin-ins and a dataflow direction to provide improved timing, reduced congestion, greater density and greater utilization for an integrated circuit design.

More specifically, a VHDL compiler compiles a hardware design to provide a netlist to a netlist parser. The netlist parser parses netlist lines to identify predetermined usage box functions and tags the usage box functions as dataflow blocks if the input signals to the function have at least a minimum width. Tagged dataflow blocks are placed by identifying pin-ins, tracing forward from the pin-ins to a tagged dataflow block and aligning the tagged dataflow block with the pin-in along an axis aligned with dataflow direction. If tracing forward identifies additional tagged dataflow blocks, these subsequent dataflow blocks are aligned along the same axis. Tagged dataflow blocks are also placed by finding pin-outs, tracing backward from the pin-outs to the tagged dataflow blocks and aligning the tagged dataflow block with the pin-out along an axis aligned with dataflow direction. Based upon global synthesis constraints, blocks are morphed to adapt to a detected dataflow structure and placed in a library for automated selection and placement.

The present invention provides a number of important technical advantages. One example of an important technical advantage is that macroblocks of an integrated circuit design are placed with improved regularity. Automatically placing regular blocks provides placement with less congestion, greater efficiency in dataflow logic and increased utilization. Automated resizing and moving regular blocks helps to optimize dataflow without additional overhead or manual intervention during placement, such as by adapting aspect ratio and total area of a block in response to constraints, such as global area, preferred aspect ratio, congestion metrics and timing criticality.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for automated integrated circuit block placement;

FIG. 2 depicts, a flow diagram of a process for parsing a netlist to detect predetermined dataflow blocks for tagging the detected dataflow blocks with keywords;

FIG. 3 depicts a flow diagram of a process for placement of dataflow macroblocks based upon keywords tagged according to dataflow block width;

FIGS. 3A, 3B and 3C depict placement of cells of an integrated circuit; and

FIG. 4 depicts a flow diagram of block morphing to dynamically adapt a macroblock aspect ratio and or total area from discrete types of a given library that are logically equivalent.

### DETAILED DESCRIPTION

A system and method provides automated detection and dynamic handling of regular structures of macroblocks within an integrated circuit design. Placement information is added to a register-transfer level design of an electronic circuit by defining a set of functions as box usage elements, defining a minimum dataflow width, tagging the defined usage elements in the design if the number of usage element input signals is greater than the minimum dataflow width, and morphing the tagged usage elements to adapt aspect ratio and total area for use in the electronic circuit. A first set of instructions from a computer readable medium, such as nonvolatile memory, parses a netlist design to tag dataflow blocks, such as registers, multiplexers, ecc, parity, and buffer blocks, with keywords that are readable during synthesis. A second set of instructions from a computer readable medium builds dataflow blocks out of standard library cells that are morphed to adapt to desired aspect ratio and area. A third set of instructions stored in a computer readable medium performs preferred and regular placement of the blocks to improve dataflow, such as by applying constraints relating to global area, preferred aspect ratio, congestion and timing criticality for the design.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

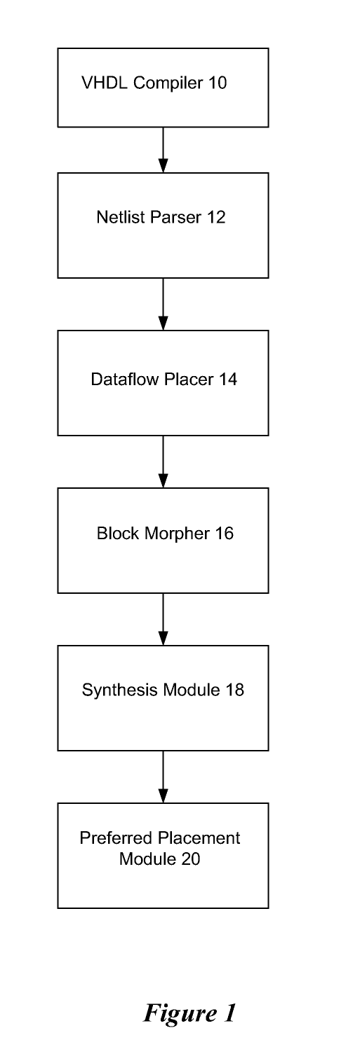

Referring now to FIG. 1, a block diagram depicts a system for automated integrated circuit block placement. Each functional block is, for instance, instructions in C++ that are stored in a computer readable medium, such as a hard disk drive or random access memory, and executed on a processor. A VHDL compiler 10 initiates a synthesis process with execution of a VHDL compile of a hardware design for an integrated circuit to generate a netlist. A netlist parser 12 parses the netlist to place keyword tags on dataflow blocks within the netlist for identification of the dataflow blocks during synthesis. A dataflow placer 14 adds additional keywords on the tagged dataflow blocks to identify dataflow direction associated with the dataflow blocks. A block morpher 16 analyzes tagged dataflow blocks to dynamically adapt the dataflow blocks to the design. A synthesis module 18 performs synthesis of the netlist enabled to read netlist keywords used to tag dataflow blocks. After synthesis performs technology mapping, a preferred placement module 20 performs a preferred placement of tagged dataflow blocks to achieve desired design specifications. After preferred placement, synthesis is completed by performing placement of non-dataflow blocks, electrical fixes, cleanup of violations and routing. The result of the synthesis as modified by the keywords is a highly regular placement of dataflow elements in a fully automated process.

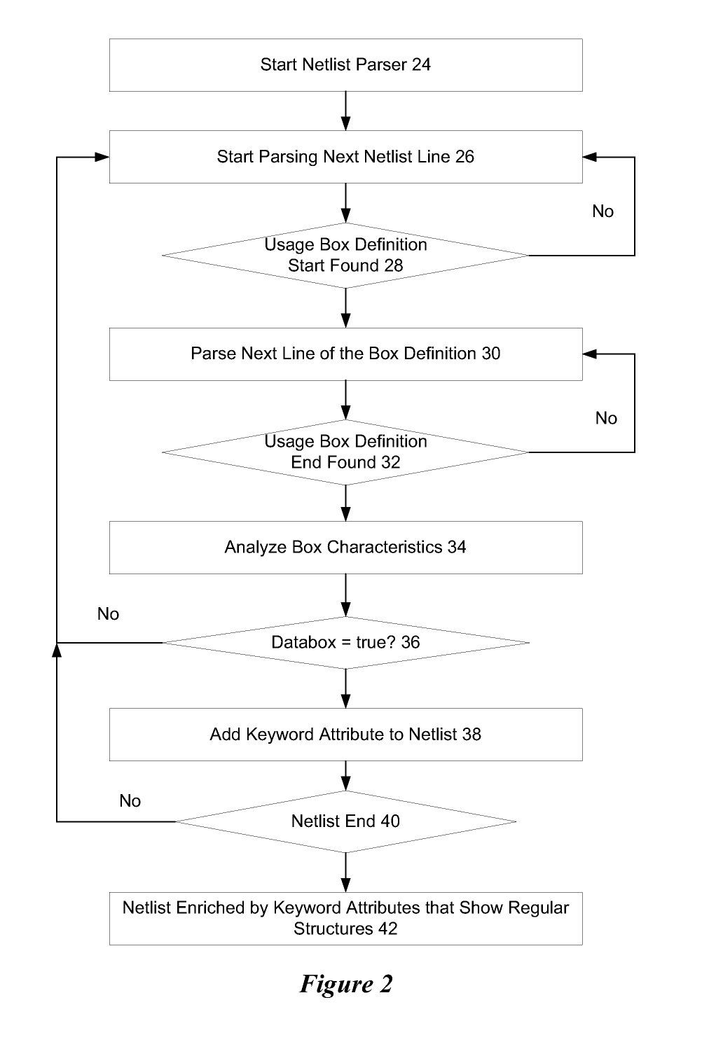

Referring now to FIG. 2, a flow diagram depicts a process for parsing a netlist to detect predetermined dataflow blocks and tag the detected dataflow blocks with keywords. At step 24, the netlist parser of FIG. 2 operates on a generic flat netlist which is output from a typical Hardware Design Language (HDL) compile step. At step 26, the parser begins operation on the next line of the netlist. At step 28, the parser determines if the netlist line has a usage box definition from a predetermined list of box usage definitions associated with dataflow, such as combinatorial and sequential function elements. In one embodiment, an example default set of box usage definitions having combinatorial and sequential function elements are: NOT, BUFF, AND, OR, XOR, GATE_OR, and LATCH. If a box usage from the predetermined list is not found, the process returns to step 26 to iteratively parse the next line of the netlist. If a predetermined box usage is found, the process continues to step 30 parse the next line of the box definition and step 32 to see if the box definition end is found. The process iteratively repeats steps 30 and 32 until the box definition end is found and then continues to step 34 to analyze the box characteristics to determine whether to tag the box. For example, the box is tagged as dataflow if at least one of the box input signals has a width of greater than a minimum dataflow width. At step 36, if the dataflow box does not have an input width greater than the minimum width, the test is false and the process returns to the next iteration at step 26. If at step 36 the dataflow box has an input width greater than the minimum width, the test is true and the process continues to step 38 to add a keyword attribute to the netlist for identification of the box at synthesis. At step 40, if the end of the netlist is not reached, the process returns to step 26 to parse the next line. If at step 40 the end of the netlist is reached, the netlist is enriched with keyword attributes to show regular structures for use at synthesis.

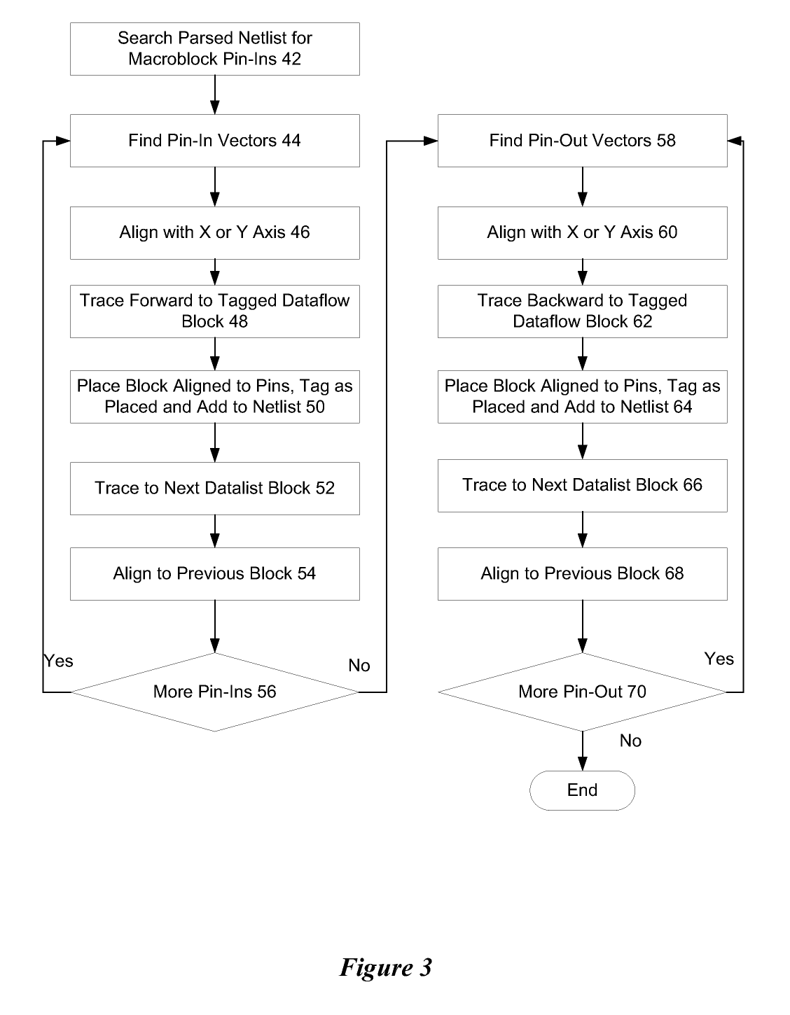

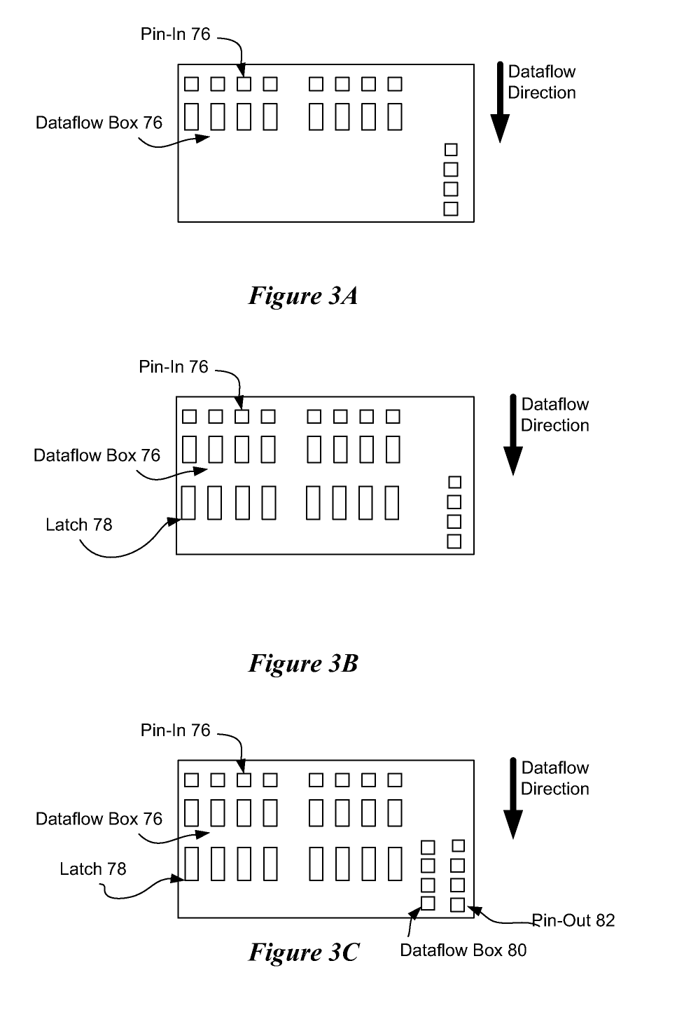

Referring now to FIG. 3, a flow diagram depicts a process for placement of dataflow macroblocks based upon keywords tagged according to dataflow block width. The process starts at step 42 with a search of the parsed netlist from the process of FIG. 2 for pin-ins. At step 44 iteratively each pin in vector is addressed and at step 46 analyzed to see if the vector has a regular alignment in the x or y direction. At step 48, the pin in vector is traced forward to a tagged dataflow block so that at step 50 the dataflow block is aligned to the pin in, is tagged as placed and added to the netlist as placed. FIG. 3A depicts an example of an iteration of placement of dataflow boxes 74 aligned with pin-ins 76. At step 52, the process continues by tracing forward from the dataflow box 74 to the next dataflow box, such as the latch 78 depicted by FIG. 3B. At step 54, the next dataflow block is aligned with the pins and the dataflow direction. Steps 52 and 54 are continued until forward tracing does not find additional databoxes. The process continues to step 56 to complete forward tracing of pin-ins by returning to step 44. At step 56 once all pin-ins are traced, the process continues to step 58 to identify pin-out vectors from the netlist. At step 58 iteratively each pin out vector is addressed and at step 60 analyzed to see if the vector has a regular alignment in the x or y direction. At step 62, the pin in vector is traced backward to a tagged dataflow block so that at step 64 the dataflow block is aligned to the pin out, is tagged as placed and added to the netlist as placed. At step 66, the process continues by tracing backward from the dataflow box to the next dataflow box. At step 68, the next dataflow block is aligned with the pins and the dataflow direction. At step 70 a determination is made of whether steps 66 and 68 are continued until backward tracing does not find additional databoxes. FIG. 3C depicts an example of placement of dataflow boxes to align with the pin-out 82. During tracing forward and backwards, if no regular pin placement is found, dataflow blocks are dropped and placed as standard gates so that dataflow keywords are ignored in subsequent synthesis steps.

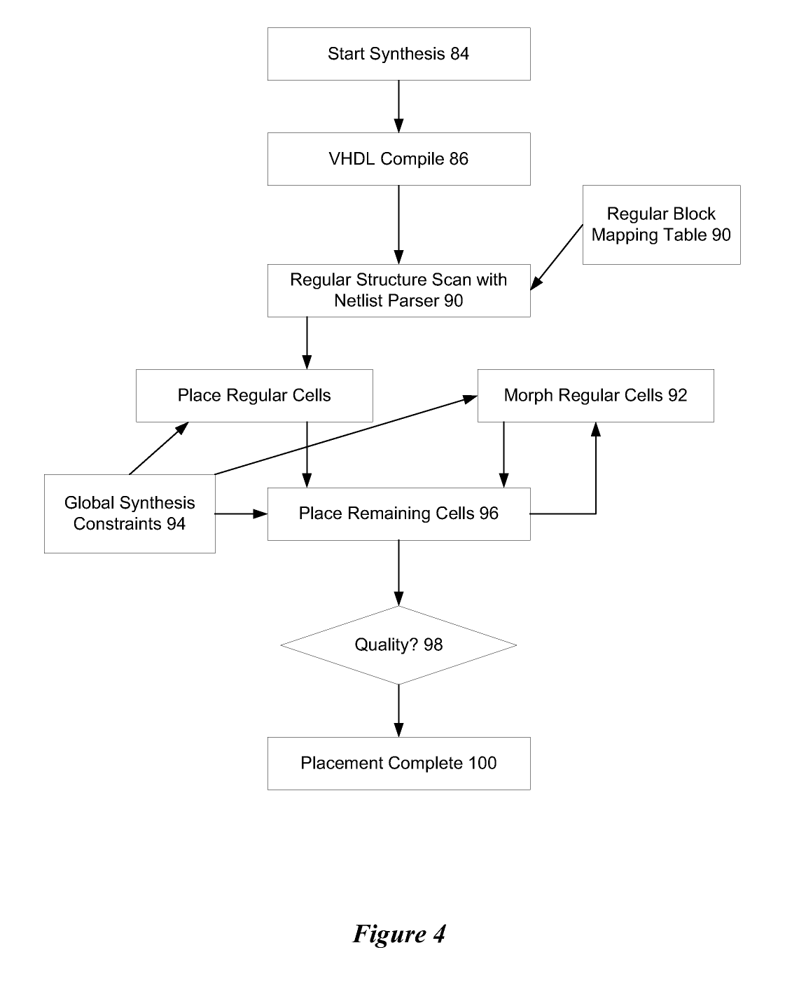

Referring now to FIG. 4, a flow diagram depicts block morphing to dynamically adapt a macroblock aspect ratio and or total area from discrete types of a given library that are logically equivalent. A library referenced for macroblocks includes scalable blocks can resize so that synthesis has full control to choose one of several block variants that have a mapped relationship to each other. For example, synthesis selects a block based on one or more predetermined constraints, such as global area, preferred aspect ratio, congestion metrics and timing criticality. The process begins at step 84 with initiation of a synthesis run for an integrated circuit design and continues to step 86 for a VHDL compile to create a netlist. At step 88, regular structures are identified and tagged based upon regular block mapping table of step 90. At step 92, selected regular cells are morphed or changed in area and aspect ratio based on global synthesis constraints 94. For example, different configurations of a block are mapped to each other with each version having specified characteristics. Regular cells may be adjusted by choosing between horizontal or vertical configurations based upon dataflow direction. Other adjustments may include speed and power, such as selection of fast high power mux with transmission-gate based regular Vt or slow low power mux with nand-based high Vt or such as a slow small area version of a block versus a fast large area version. Other adjustments might include selection of a variety of aspect ratios. At step 96, the remainder of cells are placed based upon normal synthesis constraints and at step 98 quality is checked to complete placement at step 100.

Although the present invention has been described in detail, it should be understood that various changes, substitutions and alterations can be made hereto without departing from the spirit and scope of the invention as defined by the appended claims.

What is claimed is:

1. A method for placing blocks of an electronic circuit comprising:
identifying dataflow blocks in an electronic circuit design according to one or more predetermined factors, each dataflow block having a number of input signals;
automatically comparing the number of input signals of each dataflow block with a predetermined width; and
tagging those dataflow blocks that have the number of input signals of greater than the predetermined width, the tagging with a predetermined attribute.

2. The method of claim 1 wherein the design comprises a netlist.

3. The method of claim 1 wherein the design comprises a hardware description language file.

4. The method of claim 1 wherein the predetermined factors comprise a block having a register structure.

5. The method of claim 1 wherein the predetermined factors comprise a block having a multiplexer structure.

6. The method of claim 1 wherein the predetermined factors comprise a block having a buffer structure.

7. The method of claim 1 wherein the predetermined factors comprise a latch structure.

8. The method of claim 1 further comprising:
locating a pin-in vector of the design;
determining alignment of the pin-in vector with an axis;
tracing forward from the pin-in vector to a tagged dataflow block; and
aligning the tagged dataflow block with the axis.

9. The method of claim 8 further comprising:
tracing forward from the tagged dataflow block to a subsequent tagged dataflow block; and
aligning the subsequent tagged dataflow block with the tagged dataflow block.

10. The method of claim 1 further comprising:
locating a pin-out vector of the design;
determining alignment of the pin-out vector with an axis;
tracing backwards from the pin-out vector to a tagged dataflow block; and
aligning the tagged dataflow block with the axis.

11. A method for placing blocks of an integrated circuit design, the method comprising:
identifying predetermined of the blocks as dataflow blocks;
comparing the pin-ins of dataflow blocks with a minimum width;
tagging dataflow blocks having greater than the minimum width; and
placing tagged dataflow blocks in a predetermined manner.

12. The method of claim 11 wherein the predetermined manner comprises alignment of the tagged dataflow block and pin-ins associated with the dataflow block along a common axis.

13. The method claim 11 wherein the predetermined manner comprises alignment of the tagged dataflow block and pin-outs associated with the dataflow block along a common axis.

14. The method of claim 11 wherein identifying predetermined of the blocks as dataflow blocks further comprises identifying NOT box usage as a dataflow block.

15. The method of claim 11 wherein identifying predetermined of the blocks as dataflow blocks further comprises identifying AND box usage as a dataflow block.

16. The method of claim 11 wherein identifying predetermined of the blocks as dataflow blocks further comprises identifying OR box usage as a dataflow block.

17. A system for placing blocks from a netlist, the system comprising:
a netlist parser stored in a computer readable medium and operable to parse the netlist to tag blocks in the netlist that have a predetermined function and a predetermined input signal width; and
a dataflow placer stored in a computer readable medium and operable to trace forward from a pin-in to a first block having a tag and to place the pin-in and first block along a common axis.

18. The system of claim 17 wherein the predetermined input signal width comprises a width of greater than a minimum width.

19. The system of claim 17 wherein the predetermined function comprises combinatorial and sequential function elements.

20. The system of claim 17 wherein the dataflow placer is further operable to trace backward from a pin-out to a second block having a tag and to place the pin-out and second block along a common axis.
